(19) United States
(12) Patent Application Publication
(10) Pub. No.: US 2023/0009659 A1
(43) Pub. Date: Jan. 12, 2023

(54) GLOVES CAPABLE OF AUTOMATICALLY STARTING AND STOPPING HEATING FUNCTION

(71) Applicant: Yanli Zhang, Tanghe (CN)

(72) Inventor: Yanli Zhang, Tanghe (CN)

(21) Appl. No.: 17/949,260

(22) Filed: Sep. 21, 2022

(30) Foreign Application Priority Data
Aug. 25, 2022 (CN) 202222245577.1

(51) Int. Cl. A41D 19/015

(52) U.S. Cl. CPC A41D 19/01535

(57) ABSTRACT

The present disclosure discloses gloves capable of automatically starting and stopping a heating function. Each glove includes a glove body; the glove body is internally provided with a heating unit and a control unit, and is at least provided with a first sensing element and a second sensing element; and the first sensing element and the second sensing element are disposed in a spacing manner and are both connected to the control unit. When the first sensing element and the second sensing element sequentially sense that there is a hand signal, the control unit controls the heating unit to perform heating; and when the second sensing element and the first sensing element sequentially sense that the hand signal disappears, the control unit controls the heating unit to stop heating.

### TECHNICAL FIELD

The present disclosure relates to the technical field of gloves, in particular to gloves capable of starting and stopping a heating function.

### BACKGROUND

In cold winter, gloves are essential for keeping warm outside. In existing heating gloves, heating is started or stopped by pressing a switch on a control circuit board by a hand, that is, a heating function needs to be started or stopped by pressing the switch by a hand.

However, it is not very convenient for a user to press the switch with a finger after some heating gloves are worn on both hands. Furthermore, warmer gloves are filled with more cotton, which makes the gloves thicker. In order to ensure a certain waterproof effect, surfaces of the gloves will also be waterproofed by leather or a waterproof coating or other methods. These designs will increase the inconvenience for the gloves. At the same time, it is also inconvenient to press a small-sized object such as a switch if glove fingers are oversized.

In addition, a user often forgets to stop the heating function after taking off the heating gloves. As a result, the gloves continue to generate heat when they are not used, which in turn leads to a waste of power of the gloves and may cause inconvenience to next use due to low power.

In view of this, it is necessary to provide gloves capable of automatically starting and stopping a heating function to overcome the above-mentioned defects.

### SUMMARY

The present disclosure aims to provide gloves capable of automatically starting and stopping a heating function, and aims at improving the problem that it is inconvenient to start and stop the heating function of existing heating gloves. Automatic start and stop of the heating function of the gloves are achieved; the convenience of use by a user is improved; and the situation that the user forgets to stop the heating function after taking off the gloves is also effectively avoided.

In order to achieve the above purpose, the present disclosure provides gloves capable of automatically starting and stopping a heating function, each glove including a glove body, wherein the glove body is internally provided with a heating unit and a control unit, and is at least provided with a first sensing element and a second sensing element; the first sensing element and the second sensing element are disposed in a spacing manner and are both connected to the control unit; when the first sensing element and the second sensing element sequentially sense that there is a hand signal, the control unit controls the heating unit to perform heating; and when the second sensing element and the first sensing element sequentially sense that the hand signal disappears, the control unit controls the heating unit to stop heating.

In one preferable implementation manner, the control unit is further provided with an outer joint capable of extending out of the glove body; and the outer joint is used for connecting the control unit to an external power supply.

In one preferable implementation manner, the control unit includes a control switch; and the control switch is used for controlling the heating unit to be on and off.

In one preferable implementation manner, the first sensing element is arranged at a part, corresponding to a center of the back of the hand, of the glove body; and the second sensing element is arranged at one of parts, corresponding to the thumb, the index finger, the middle finger, the ring finger and the little finger, of the glove body.

In one preferable implementation manner, each of the first sensing element and the second sensing element is one of a touch sensing plate, a photoelectric sensing plate and a body pyrothermal infrared sensing plate.

In one preferable implementation manner, the first sensing element and the second sensing element, as well as sensing circuits corresponding to the first sensing element and the second sensing element, are all fixed on a fixed sheet; the fixed sheet is fixed inside the glove body; and the sensing circuits are electrically connected to the control unit through several connecting wires.

In one preferable implementation manner, the glove body includes a glove cover and a lining fixed in the glove cover; and the heating unit, the first sensing element and the second sensing element are all arranged between the glove cover and the lining.

In one preferable implementation manner, a sponge piece is further arranged between the glove cover and the lining; and the sponge piece wraps and fixes the fixed sheet on the lining.

In one preferable implementation manner, a thermal insulation layer is further arranged between the glove cover and the lining; and the thermal insulation layer is arranged between the glove cover and the heating unit.

In one preferable implementation manner, the heating unit includes a heat generation sheet and a heat dissipation film connected to the heating sheet; and the heat generation sheet and the heat dissipation film are jointly encircled to form an integrated structure matched with the glove body.

According to the gloves capable of automatically starting and stopping a heating function provided by the present disclosure, the first sensing element and the second sensing element are arranged in the glove body in a spacing manner. When the first sensing element and the second sensing element sequentially sense that there is a hand signal, it indicates that a user stretches into the glove body with a hand; and at this time, the control unit controls the heating unit to perform heating, instead of starting the heating function by means of manually pressing a switch. When the second sensing element and the first sensing element sequentially sense that the hand signal disappears, it indicates that the user takes off the glove body; and at this time, the control unit controls the heating unit to stop heating, avoiding the situation that the user forgets to stop the heating function after taking off the gloves. In addition, when the user holds the heating gloves in hands, even if one of the first sensing element and the second sensing element senses the hand signal or both of the first sensing element and the second sensing element sense the hand signal at the same time, the control unit will not send a heating instruction to the heating unit, so that interference is eliminated by a predetermined order of actions, avoiding the phenomenon that the heating function is started by mistake because the gloves are held in hands after being taken off.

### BRIEF DESCRIPTION OF THE DRAWINGS

In order to explain the technical solutions of the embodiments of the present disclosure more clearly, the following will briefly introduce the accompanying drawings used in the embodiments. It should be understood that the drawings in the following description only illustrate some embodiments of the present disclosure and thus shall not be deemed as limiting the scope. Those of ordinary skill in the art can obtain other related drawings according to these drawings without creative work.

FIG. 1 is a front view of a glove capable of automatically starting and stopping a heating function provided by the present disclosure;

FIG. 2 is a three-dimensional view of the glove capable of automatically starting and stopping a heating function shown in FIG. 1;

FIG. 3 is a front view of the glove capable of automatically starting and stopping a heating function shown in FIG. 1, with part of a glove main body being hidden;

FIG. 4 is a sectional exploded diagram of the glove capable of automatically starting and stopping a heating function shown in FIG. 1;

FIG. 5 is a three-dimensional sectional view of the glove capable of automatically starting and stopping a heating function shown in FIG. 1;

FIG. 6 is a sectional front view of the glove capable of automatically starting and stopping a heating function shown in FIG. 5;

FIG. 7 is a partially enlarged diagram of circle part A in FIG. 6.

Reference numerals in the drawings: 100: glove capable of automatically starting and stopping a heating function; 10: glove body; 11: glove cover; 12: lining; 13: heating unit; 14: control unit; 141: outer joint; 142: control switch; 15: first sensing element; 16: second sensing element; 17: fixed sheet; 18: connecting wire; 19: sponge piece; and 20: thermal insulation layer.

### DETAILED DESCRIPTION OF THE EMBODIMENTS

In order to make the objectives, technical solutions and beneficial technical effects of the present disclosure clearer, the present disclosure is further described in detail below with reference to accompanying drawings and specific implementations. It should be understood that the specific implementations described in this specification are only used to explain the present disclosure, not intended to limit the present disclosure.

It should also be understood that the terms used in the specification of the present disclosure are for the purpose of describing particular embodiments only and are not intended to limit the present disclosure. As used in this specification and the appended claims of the present disclosure, the singular forms “a” “an” and “the” are intended to include the plural unless the context clearly dictates otherwise.

It should also be further understood that, the term “and/or” used in this specification and the appended claims of the present disclosure refers to any and all possible combinations of one or more of the associated listed items and includes these combination.

In an embodiment of the present disclosure, gloves 100 capable of automatically starting and stopping a heating function is provided, which is used for achieving automatic starting and stopping of the heating function of the glove and improving the convenience of use by a user.

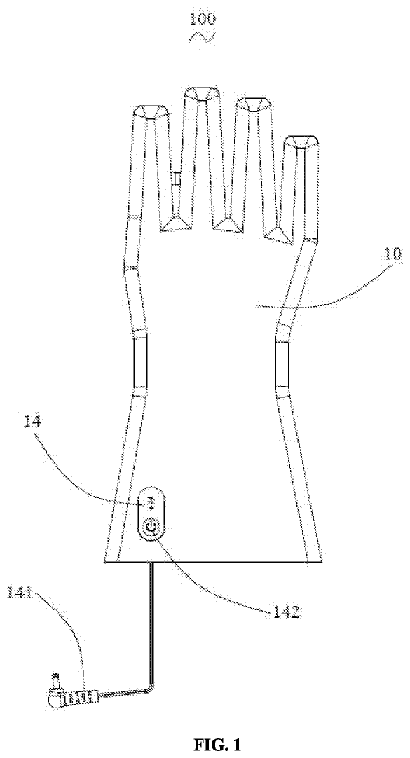

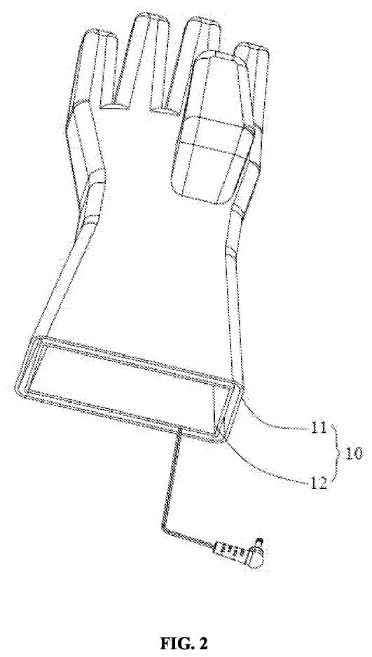

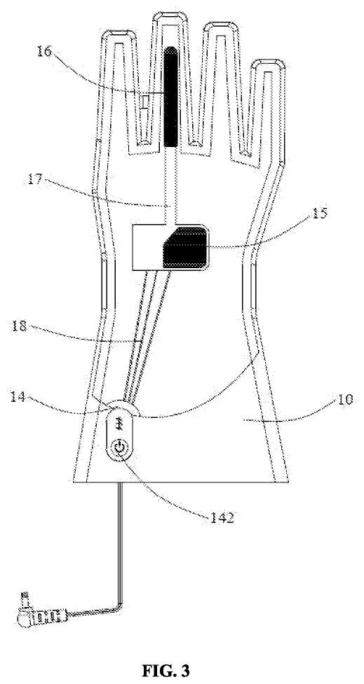

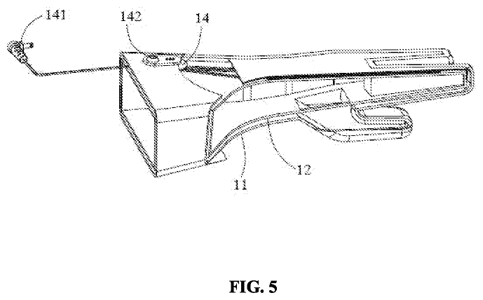

As shown in FIG. 1 to FIG. 7, the glove 100 capable of automatically starting and stopping a heating function includes a glove body 10. Generally, the glove body 10 includes a palm part used for wrapping the palm of a user and finger parts used for respectively wrapping the five fingers of the user. The palm part further includes a palm center region corresponding to the center of the palm of the user and a hand back region corresponding to the back of the hand of the user. It can be understood that the structure of the glove body 10 corresponding to the left hand and the structure of the glove body 10 corresponding to the right hand are mirrored with each other. Therefore, the glove body 10 of the present disclosure includes the structure of the glove body 10 corresponding to the left hand and also includes the structure of the glove body 10 corresponding to the right hand. Both of the structures fall within the protection scope of the present disclosure.

Specifically, the glove body 10 includes a glove cover 11 and a lining 12 fixed in the glove cover 11. The lining 12 is in direct contact with the skin of the hand of the user and can sleeve the hand of the user. The glove cover 11 may be a material with certain intensity, such as leather. Furthermore, a waterproof coating can be arranged on a surface to improve the waterproof property of the glove body 10. The glove cover 11 and the lining 12 are jointly encircled to form an accommodating structure.

In the embodiment of the present disclosure, the glove body 10 is internally provided with a heating unit 13 and a control unit 14 and is at least provided with a first sensing element 15 and a second sensing element 16. Specifically, the heating unit 13, the first sensing element 15 and the second sensing element 16 are all arranged in the accommodating structure between the glove cover 11 and the lining 12.

The heating unit 13 includes a heat generation sheet and a heat dissipation film connected to the heat generation sheet. The heat generation sheet may generate heat after being electrified, and the heat is uniformly conducted to all the parts of the glove body 10 through the heat dissipation film. Further, the heat generation sheet and the heat dissipation film are jointly encircled to form an integrated structure matched with the glove body 10, so as to be attached and fixed between the glove cover 11 and the lining 12.

The first sensing element 15 and the second sensing element 16 are arranged in a spacing manner and are both connected to the control unit 14.

The control unit 14 may be a processor with a certain data processing capability, such as a micro processor, a single-chip microcomputer and a chip, and may realize a preset function through a preset program. For example, the control unit sends a heating instruction or a heating stop instruction to the heating unit 13 after receiving predetermined data.

Each of the first sensing element 15 and the second sensing element 16 is one of a touch sensing plate, a photoelectric sensing plate and a body pyrothermal infrared sensing plate, and may also be other sets of sensing equipment with a human body sensing function. That is, the first sensing element 15 and the second sensing element 16 may sense the hand of the user within a predetermined distance through touch sensing, infrared sensing and the like, thus generating corresponding sensing signals.

Further, the first sensing element 15 may be arranged at a part, corresponding to a center of the back of the hand, of the glove body 10; and the second sensing element 16 is arranged at one of parts, corresponding to the thumb, the index finger, the middle finger, the ring finger and the little finger, of the glove body 10. In this embodiment, the second sensing element 16 is arranged at the part corresponding to the middle finger.

Further, the first sensing element 15 and the second sensing element 16, as well as sensing circuits corresponding to the first sensing element and the second sensing element, are all fixed on a fixed sheet 17. The fixed sheet 17 may be a flexible leather piece or the like serving as a fixed carrier of the first sensing element 15 and the second sensing element 16. The fixed sheet 17 is fixed inside the glove body 10; and the sensing circuits are electrically connected to the control unit 14 through several connecting wires 18.

When the first sensing element 15 and the second sensing element 16 sequentially sense that there is a hand signal, it indicates that the user has stretched into the glove body 10 with a hand; and at this time, the control unit 14 controls the heating unit 13 to perform heating. When the second sensing element 16 and the first sensing element 15 sequentially sense that the hand signal disappears, it indicates that the user has pulled the hand out of the glove body 10; and at this time, the control unit 14 controls the heating unit 13 to stop heating, thereby achieving, by means of identifying actions of the user, the effect of automatically starting and stopping the heating function. It should be noted that one of the sensing elements may also be triggered when the glove body 10 is held in the hand. For example, if it is detected that only the second sensing element 16 at the middle finger part is triggered for sensing, the control unit 14 does not send an instruction for start heating at this time. Similarly, if it is only detected that the second sensing element 16 at the hand back part is triggered for sensing, the control unit will not send the instruction for start heating, either. In the same way, if it is detected that the two sensing elements are simultaneously triggered(including such a case that a time interval of triggering and sensing the two sensing elements is shorter than a preset interval threshold), the control unit will not send the instruction for start heating, either. Therefore, interference is eliminated through an action order, avoiding the phenomenon that the heating function is started by mistake because the gloves are held in hands after being taken off.

It can be understood that a plurality of sensing elements may be further arranged in the glove body 10 in the present disclosure, which is not limited to two sensing elements, such as three sensing elements. The control unit 14 will send a heating instruction or a heating stop instruction only after the three sensing elements are triggered in sequence, so as to further improve the accuracy of action identification. Therefore, arranging a plurality of sensing elements in the glove body 10 also falls within the protection scope of the present disclosure.

In one embodiment, as shown in FIG. 1 to FIG. 4, the control unit 14 is also provided with an outer joint 141 capable of extending out of the glove body 10. The outer joint 141 is used for connecting the control unit 14 to an external power supply, such as a battery arranged in the glove body 10 or a battery sleeving a wrist part or other external positions, so as to supply power to and charge the battery.

Further, the control unit 14 includes a control switch 142. The control switch 142 is used for controlling the heating unit 13 to be turned on and turned off. When the glove is left unused for long time, the control switch 142 may be turned off to avoid the battery and the control unit 14 from being standby for long time.

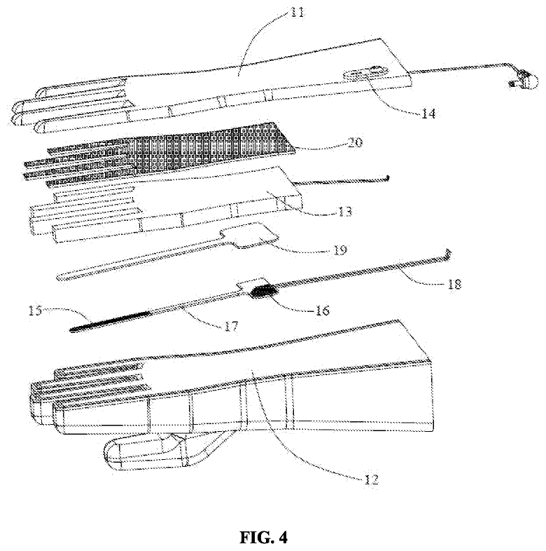

In one embodiment, as shown in FIG. 4, a sponge piece 19 is also arranged between the glove cover 11 and the lining 12. The sponge piece 19 wraps and fixes the fixed sheet 17 on the lining 12 to avoid the first sensing element 15 and the second sensing element 16 from moving in the glove body 10.

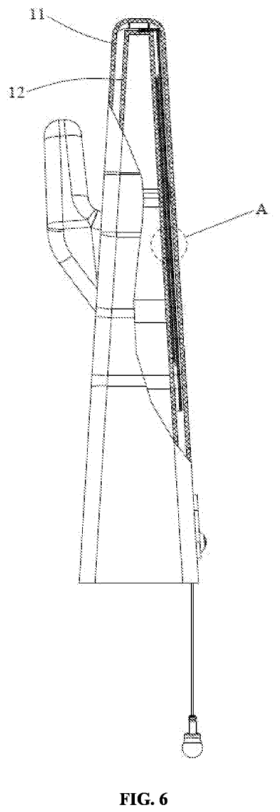

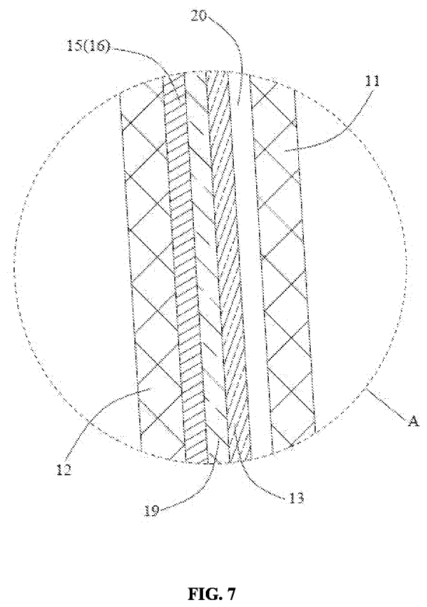

In one embodiment, as shown in FIG. 6 and FIG. 7, a thermal insulation layer 20 is also arranged between the glove cover 11 and the lining 12. The thermal insulation layer 20 can be filled with a material with thermal insulation property, such as sponge, and is arranged between the glove cover 11 and the heating unit 13, so as to keep the heat generated by the heating unit 13.

The implementation principle of the present disclosure includes the following steps:

(1) The control unit 14 is electrically connected to the power supply through the outer joint 141, and the control switch 142 is turned on.

(2) The first sensing element 15 and the second sensing element 16 respectively separately detect hand signals, and send the respective detected hand signals to the control unit 14 in real time or at a preset time interval (such as 5 s).

(3) The control unit 14 determines and analyzes the hand signals sent by the first sensing element 15 and the second sensing element 16; if it is determined that the first sensing element 15 and the second sensing element 16 detect the hand signals in sequence, the control unit 14 sends a heating instruction to the heating unit 13; and if it is determined that the second sensing element 16 and the first sensing element 15 detect in sequence that the hand signals disappear, the control unit 14 sends a heating stop instruction to the heating unit 13.

(4) The heating unit 13 performs heating according to the received heating instruction, or stops heating according to the received heating stop instruction.

Further, in any one of the following four cases, the control unit 14 determines that the sensing elements are abnormally triggered, and will not send the heating instruction or the heating stop instruction to the heating unit 13: in the first case, only the first sensing element 15 detects a hand signal; in the second case, only the second sensing element 16 detects a hand signal; in the third case, the first sensing element 15 and the second sensing element 16 detect a hand signal at the same time (including such a case that a time interval of triggering the two sensing elements for sensing is shorter than a first preset interval threshold); and in the fourth case, the first sensing element 15 and the second sensing element 16 detect at the same time that the hand signal disappears (including such a case that a time interval of triggering the two sensing elements for sensing is shorter than a second preset interval threshold).

To sum up, according to the gloves 100 capable of automatically starting and stopping a heating function provided by the present disclosure, the first sensing element 15 and the second sensing element 16 are arranged in the glove body 10 in a spacing manner. When the first sensing element 15 and the second sensing element 16 sequentially sense that there is a hand signal, it indicates that a user stretches into the glove body 10 with a hand; and at this time, the control unit 14 controls the heating unit 13 to perform heating, instead of starting the heating function by means of manually pressing a switch. When the second sensing element 16 and the first sensing element 15 sequentially sense that the hand signal disappears, it indicates that the user takes off the glove body 10; and at this time, the control unit 14 controls the heating unit 13 to stop heating, avoiding the situation that the user forgets to stop the heating function after taking off the gloves. In addition, when the user holds the heating gloves in hands, even if one of the first sensing element 15 and the second sensing element 16 senses the hand signal or both of them sense the hand signal at the same time, the control unit 14 will not send a heating instruction to the heating unit 13, so that interference is eliminated by a predetermined order of actions, avoiding the phenomenon that the heating function is started by mistake because the gloves are held in hands after being taken off.

The present disclosure is not limited only to what is described in the specification and implementations, so that those skilled in the art can easily realize additional advantages and modifications. Therefore, the present disclosure is not limited to specific details, representative equipment and diagram examples shown and described here without departing from the spirit and scope of general concepts defined by the claims and equivalent ranges.

What is claimed is:

1. Gloves capable of automatically starting and stopping a heating function, each glove comprising a glove body, wherein the glove body is internally provided with a heating unit and a control unit, and is at least provided with a first sensing element and a second sensing element; the first sensing element and the second sensing element are disposed in a spacing manner and are both connected to the control unit; when the first sensing element and the second sensing element sequentially sense that there is a hand signal, the control unit controls the heating unit to perform heating; and when the second sensing element and the first sensing element sequentially sense that the hand signal disappears, the control unit controls the heating unit to stop heating.

2. The gloves capable of automatically starting and stopping the heating function according to claim 1, wherein the control unit is further provided with an outer joint capable of extending out of the glove body; and the outer joint is used for connecting the control unit to an external power supply.

3. The gloves capable of automatically starting and stopping the heating function according to claim 1, wherein the control unit comprises a control switch; and the control switch is used for controlling the heating unit to be on and off.

4. The gloves capable of automatically starting and stopping the heating function according to claim 1, wherein the first sensing element is arranged at a part, corresponding to a center of the back of the hand, of the glove body; and the second sensing element is arranged at one of parts, corresponding to the thumb, the index finger, the middle finger, the ring finger and the little finger, of the glove body.

5. The gloves capable of automatically starting and stopping the heating function according to claim 1, wherein each of the first sensing element and the second sensing element is one of a touch sensing plate, a photoelectric sensing plate and a body pyrothermal infrared sensing plate.

6. The gloves capable of automatically starting and stopping the heating function according to claim 1, wherein the first sensing element and the second sensing element, as well as sensing circuits corresponding to the first sensing element and the second sensing element, are all fixed on a fixed sheet; the fixed sheet is fixed inside the glove body; and the sensing circuits are electrically connected to the control unit through several connecting wires.

7. The gloves capable of automatically starting and stopping the heating function according to claim 6, wherein the glove body comprises a glove cover and a lining fixed in the glove cover; and the heating unit, the first sensing element and the second sensing element are all arranged between the glove cover and the lining.

8. The gloves capable of automatically starting and stopping the heating function according to claim 7, wherein a sponge piece is further arranged between the glove cover and the lining; and the sponge piece wraps and fixes the fixed sheet on the lining.

9. The gloves capable of automatically starting and stopping the heating function according to claim 7, wherein a thermal insulation layer is further arranged between the glove cover and the lining; and the thermal insulation layer is arranged between the glove cover and the heating unit.

10. The gloves capable of automatically starting and stopping the heating function according to claim 1, wherein the heating unit comprises a heat generation sheet and a heat dissipation film connected to the heat generation sheet; and the heat generation sheet and the heat dissipation film are jointly encircled to form an integrated structure matched with the glove body.
